(19) United States
(12) Patent Application Publication
(10) Pub. No.: US 2019/0283361 A1
(43) Pub. Date: Sep. 19, 2019

(54) COMPOSITE LAMINATE HAVING A HONEYCOMB CORE, AND METHOD FOR THE MANUFACTURE THEREOF

(71) Applicant: E.I DU PONT DE NEMOURS AND COMPANY, Wilmington, DE (US)

(72) Inventors: ZHI GANG JIA, Shanghai (CN); Lei JIN, Shanghai (CN); Tao SONG, Shanghai (CN)

(21) Appl. No.: 16/131,719

(22) Filed: Sep. 14, 2018

(30) Foreign Application Priority Data
Mar. 15, 2018 (CN) 201810216712.5
Mar. 15, 2018 (CN) 201820356461.6

(51) Int. Cl. B32B 3/12; B32B 7/12; B32B 5/02; B32B 27/12; B32B 3/08; B29C 70/34; B29C 70/86

(52) U.S. Cl. CPC B32B 3/12; B32B 7/12; B32B 5/02; B32B 27/12; B29L 2031/30; B29C 70/345; B29C 70/86; B32B 2605/00; B32B 3/08

(57) ABSTRACT

A composite laminate comprises a preform and two skin layers covering the outer surfaces of the perform, wherein the preform comprises a honeycomb core, adhesive films and barrier films laid in sequence on its two outer surfaces, and a plurality of tubular rivets inserted through the preform. Also disclosed are methods for manufacturing the composite laminate by a vacuum-assisted resin infusion (VARI) method.

### TECHNICAL FIELD

The present invention relates to a composite laminate having a honeycomb core, and a method for the manufacture thereof, specifically via a liquid molding process.

### BACKGROUND ART

Honeycomb core composite panels have gained wide use in different applications due to their light weight, high strength and high stiffness, but they are primarily used in the aerospace and aircraft industries as well as mass transit vehicles, including aircraft floor panels, secondary structures, roof panels, wall panels, luggage racks and other components as well as train floor panels, skirtboards, car roofs, luggage racks, partitions and other components. Said honeycomb core composite panels generally employ a prepreg containing a binder as an upper and lower skin, with examples including epoxy and phenolic prepregs, and are then prepared via conventional autoclave molding methods. Therefore, the requirements pertaining to prepreg uniformity as well as prepreg resin fluidity are correspondingly high, which not only itself increases processing costs and energy consumption, but processing costs and energy consumption are also further increased due to mold size limitations.

On the other hand, liquid forming processes employ a closed mold or a semi-closed mold, and a non-prepreg is used as for the upper and lower skin with only a small amount of auxiliary material used, so costs are kept low, and liquid resin is highly flowable before molding so at least one surface of the article is smooth and uniform and no limitations are imposed by the size of the mold. Therefore, preparation of a honeycomb core composite panel via a liquid molding process provides several obvious advantages over the aforementioned autoclave molding methods. In the aerospace industry, the most significant advantage provided by the liquid forming process is the latter's ability to produce complex shapes—i.e., combining multiple finely detailed components into a single structure.

The key issue in this case is the fact that the core structure of a honeycomb core composite panel includes open pores and in order to prevent liquid resin from flowing into the pores, resulting in an unnecessary increase in weight, a separator film is usually used to seal both sides of the core material. For example, EP0722825A1 discloses the use of a combination of a film, prepreg, and dry fabric to produce a honeycomb core composite panel via a resin transfer molding process. However, if a prepreg is not used and only dry fabric is used for the upper and lower skin, liquid resin injected from one side cannot quickly and uniformly wet the skin on the opposite side, resulting in an uneven surface resin and shorts. One solution to the aforementioned problem is to place a resin flow-guiding web on at least the opposite side of the feed side, but when this method is used it is not possible to obtain a finished article with at least one surface that is smooth and uniform. However, typical features of components used in the aerospace industry include aerodynamics, decorative surfaces and controlled fit-up surfaces. Therefore, the surface characteristics of honeycomb core composite boards used for such components correspondingly have high quality requirements.

### SUMMARY OF THE INVENTION

The present invention provides a composite laminate having a honeycomb core, which in sequence comprises:

(a) A primary skin layer;

(b) A primary barrier film;

(c) A primary adhesive film;

(d) A honeycomb core;

(e) A secondary adhesive film;

(f) A secondary barrier film;

(g) A secondary skin layer;

(h) A plurality of tubular rivets;

(i) A self-expanding sealant wrapped around said tubular rivets; and

(j) A matrix derived from a liquid binder;

wherein,

said liquid binder is selected from a set consisting of phenolic resin, epoxy resin, unsaturated polyester resin, vinyl ester resin, and combinations thereof; and has a viscosity of 100 cp to 500 cp at 25° C.;

said layers (b), (c), (d), (e), and (f) are stacked in sequence to form a preform; and

said tubular rivets are inserted through the preform and set apart from each other in a distance of 30 mm to 200 mm

The present invention also provides a method for the manufacture of said composite laminate, wherein:
i) The (b) primary barrier film, (c) primary adhesive film, (d) honeycomb core, (e) secondary adhesive film, and (f) secondary barrier film are stacked sequentially to form a preform;
ii) Multiple tubular rivets are inserted through said preform and set apart from each other in a distance of 30 mm to 200 mm;
iii) The circumference of each tubular rivet is covered with a self-expanding sealant;
iv) The primary skin layer and secondary skin layer are used to cover the outer surface of the preform obtained in Step (iii), respectively;
v) Vacuum assisted resin infusion (VARI) is used to cure the preform covered with the primary and secondary skin layers obtained in Step (iv).

The present invention further provides articles or components found in vehicles or mobile temporary accommodations, which include a composite laminate constituted by the present invention, wherein said vehicles include cars, ships, trains, maglev trains, drones and aircraft, and said mobile temporary accommodations include cabins and mobile homes.

The present invention also provides applications for the composite laminate constituted by the present invention in the production of articles or components found in vehicles or mobile temporary accommodations, wherein said vehicles include cars, ships, trains, maglev trains, drones and aircraft, and said mobile temporary accommodations include cabins and mobile homes.

The various other features, aspects, and advantages pertaining to the present invention can be understood in greater detail by referring to the descriptions, embodiment examples and appended claims given below.

### BRIEF DESCRIPTION OF THE DRAWINGS

FIG. 1 corresponds to a schematic vertical cross-sectional view of a composite laminate constituted by the present invention, comprising both upper and lower layers of a honeycomb core, and shows tubular rivets as well as the self-expanding sealant wrapped around them.

FIG. 2 corresponds to a schematic view of a tubular rivet used in the composite laminate constituted by the present invention.

FIG. 3 corresponds to a schematic view of a tubular rivet insertion location used in some embodiments of the present invention.

### SPECIFIC EMBODIMENTS OF THE PRESENT INVENTION

For all purposes, all publications, patent applications, patents, and other references mentioned herein are hereby expressly incorporated by reference in their entirety into this text and shall be regarded as complete in their description unless otherwise specified.

Unless otherwise defined, all technical and scientific terms used herein shall have the same meaning as that understood by a person skilled in the art to which the present invention belongs. In the event of any conflicts, the definition(s) included in this specification shall prevail.

Trademarks are capitalized unless otherwise specified.

All percentages, partial fractions, ratios, etc., are given by weight unless otherwise specified.

As used herein, the terms “made of . . . ” and “including” shall be regarded as synonymous. The terms “including”, “comprising”, “containing”, “having”, “with”, or any other variants thereof, shall correspond to their non-exclusive meanings. For example, a composition, process, method, article, or device that comprises a plurality of elements shall not necessarily be limited to said elements, but may include other elements not specifically listed, or other elements inherent in such compositions, processes, methods, articles, or devices.

The phrase “consisting of . . . ” shall exclude any non-specified elements, steps or components. In the claims, the above type of phrasing shall mean that the claims do not include materials other than those recited, but may include impurities normally associated therewith. When the phrase “consisting of . . . ” appears in the body of a claim clause, rather than immediately following the preamble, it shall limit only the elements listed in the clause; other elements shall not be excluded from the claim as a whole.

The phrase “essentially consisting of . . . ” shall define a composition, method or apparatus which in addition to including the elements literally specified, shall also include other materials, steps, features, components, or elements, provided that said additional materials, steps, features, components or elements do not materially affect the basic and novel features of the claimed invention. The range covered by the term “essentially consisting of . . . ” shall reside between “comprising” and “consisting of . . . ”

The term “comprises/comprising” is intended to include embodiments covered by the terms “essentially consisting of . . . ” and “consisting of . . . ” Similarly, the term “essentially consisting of . . . ” is intended to include embodiments covered by the term “consisting of . . . ”

When an amount, concentration or other value or parameter is given in the form of a range, a preferred range or a series of larger preferred values and smaller preferred values, this should be understood to specifically disclose all value ranges formed by any pair of values (formed by any upper limit or larger preferred value and any lower limit or smaller preferred value), regardless of whether or not the range is disclosed separately. For example, when a value range of “1 to 5” is given, said range should be understood to include the ranges “1 to 4,” “1 to 3”, “1 to 2”, “1 to 2 and 4 to 5”, “1 to 3 and 5”, etc. Unless otherwise stated, where a numerical range is given herein, the corresponding value range is intended to include both endpoint values, as well as all integers and fractions within said range.

When the term “approximately” is used to describe a value or endpoint value of a range, said disclosure shall be understood to include the corresponding value or endpoint value.

Furthermore, unless expressly stated to the contrary, “or” shall mean “or” in the inclusive sense rather than the exclusive “or”. For example, any of the following shall satisfy the condition A “or” B: A is true (or exists) and B is false (or does not exist), A is false (or does not exist) and B is true (or exists), and A and B are both true (or exist).

In addition, elements or components of the present invention preceded by the article “a” or “a type of” shall refer to cases where the number of instances (i.e., the presence) of an element or component is not limited in terms of number. Therefore “a” or “an” should be understood to include one or at least one, and the singular form of the element or component shall also include the plural unless the number should obviously be singular.

“mol %” or “mole %” shall refer to a mole fraction.

In the specification and/or claims of the present invention, the term “homopolymer” shall refer to a polymer obtained by polymerizing a single type of monomer and “copolymer” shall refer to a polymer obtained via polymerization of two or more different types of monomer. Said copolymers shall include binary copolymers, tertiary copolymers and multicomponent copolymers.

As used herein, various specific polymer types such as “polyamide”, “polyester”, “polyurethane” and the like shall include not only polymers containing repeating units derived from monomers which are known to polymerize to form polymers of the type described, but may further include other copolymerizable comonomers of no more than 25 mol %, as well as derivatives thereof, etc. Furthermore, the aforementioned polymers shall also include mixtures, blends, etc. of said polymers and different classes of other polymers.

When describing certain polymers, it should be understood that the applicant may sometimes refer to a polymer by the amount of monomer used to prepare the polymer or the monomer used to prepare the polymer. While said descriptions may not include specific nomenclature describing the final polymer, or may not include explicit limitations such as “a product made by a method in which . . . ”, the expression of any such monomers and amount should be interpreted to mean monomers (such as copolymerized units of said monomers) included in said polymer, or the amounts of said monomers, as well as their corresponding polymers and compositions.

As used herein, the term “fiber” shall refer to a relatively flexible elongate body having a ratio of length to the width of the cross-section perpendicular to said length equal to more than 10. The cross section of said fiber may constitute any shape such as a circle, a pancake, or an elliptical shape, but in general shall be circular. The cross section of said fiber may be solid or hollow, and shall preferably be solid. An individual fiber may be formed from only one filament or from a plurality of filaments. Fibers formed from only one filament are referred to herein as “single filament” fibers or “monofilament” fibers and fibers formed from a plurality of filaments are referred to herein as “multifilament” fibers. As used herein, the term “yarn” shall refer to a single bundle composed of a plurality of fibers, which may be untwisted (i.e., plain) or twisted. The term “yarn” may be used interchangeably with the term “fiber.”

The thickness of a fiber is usually characterized by a measure of linear density referred to as “denier” or “dtex;” “denier” is the weight of 9,000 meters of the fiber (in grams) and “dtex” is the weight of 10,000 meters of the fiber (in grams).

As used herein, “layer” describes a generally planar arrangement of skin, barrier film, adhesive film, or reinforced fabric. As used herein, “primary X layer/film,” “secondary X layer/film” generally only indicate the laying order of the layer or the film in forming the laminated structure, and do not represent the inner/outer or upper/lower positioning in their final application within the composite laminate.

As used herein, the term “lamination” and “laminate” refer to methods by which two or more films or other sheet materials are bonded together as well as articles obtained thereby. The layers can be bonded by using an adhesive, heat, pressure, etc.

Embodiments of the present invention described in the Summary of the Invention section include any other embodiments described herein, all of which may be combined in any manner, and the description of the variables in the embodiments shall not only apply to various sheets and films of the composite laminate constituted by the present invention, they shall also apply to composite laminates pertaining to the present invention as well as articles constituted by the present invention.

The materials, methods, and examples herein are illustrative only and shall not be construed as limiting unless otherwise indicated. Although methods and materials similar or equivalent to those described herein can be used in the practice or testing of the present invention, suitable methods and materials are described herein.

The present invention is described in detail below.

Skin Layer

In the context of the present invention, the primary skin layer (a) and the secondary skin layer (g) each independently comprise at least one layer of reinforcing fabric comprising glass fiber, carbon fiber, aramid fiber, or a combination thereof.

Glass fiber is an inorganic non-metallic fiber demonstrating excellent performance characteristics. It provides the advantages of good insulation, strong heat resistance, good corrosion resistance and high mechanical strength, but it is disadvantageous in that it is brittle and shows poor resistance to wear. In the context of the present invention, reinforcing fabric preferably corresponds to a glass fiber comprising C-glass (moderately alkali glass) or E-glass (alkali-free glass).

Carbon fiber refers to inorganic polymer fiber having a carbon content of more than 90%, and graphite fiber having a carbon content of more than 99%. The advantages of carbon fiber include high warp strength and modulus, zero creep, good fatigue resistance, a small thermal expansion coefficient and good corrosion resistance, but the material is disadvantageous due to its poor impact resistance.

Aramid fiber (abbreviated as “aramid”) is heat-resistant, chemically resistant and flame retardant. In the context of the present invention, aramid fibers include poly (p-phenylene terephthalamide) homopolymer, poly (p-phenylene terephthalamide) copolymer, poly (m-phenylene isophthalate) homopolymer, poly (m-phenylene isophthalamide) copolymer, polysulfone amide homopolymer, polysulfone amide copolymer, and mixtures thereof.

As used herein, the term “para-aramid” refers to a poly (p-phenylene terephthalamide) homopolymer or poly (p-phenylene terephthalamide) copolymer; the term “meta-aramid” refers to a poly (m-phenylene isophthalamide) homopolymer or poly (m-phenylene isophthalamide) copolymer.

Commercially available glass fibers such as, but not limited to, E-Glass 468 manufactured by CPIC; commercially available carbon fibers such as, but not limited to, T700 manufactured by Toray; commercially available aramids such as, but not limited to, the Kevlar series of para-aramids as well as the ®Nomex® series of meta-aramids produced by DuPont.

It is known that the properties of reinforced fabric are not only determined by the fiber properties and yarn structure, the fabric structure and warp and weft density are also important factors. In the context of the present invention, structures suitable for reinforcing fabric include woven fabric, unidirectional fabric and non-woven fabric; a woven fabric or a non-woven fabric is preferred.

Woven fabrics generally refer to continuous filaments woven based on any form known to those skilled in the art, having a substantial number of continuous filaments in the warp and weft directions, which are generally more stable than unidirectional fabrics. Said woven fabric may be derived from any woven structure or pattern such as, but not limited to, plain weave, twill weave, satin weave, leno, square, etc.

Unidirectional fabric implies that more than 80% of the continuous filaments are arranged in parallel along the lengthwise direction (or warp direction), with more than 20% of filaments arranged in the other direction (or weft direction), and said fabrics are usually obtained from spun yarn. Many methods are available for weaving unidirectional fabrics, with common types including woven unidirectional fabrics, weftless unidirectional fabrics, and stitchbond unidirectional fabrics.

The non-woven fabric is a fabric which is formed without a warp and weft and which does not need to be spun woven; such fabrics have the advantages of light weight and easy setting. The process for manufacturing such fabrics usually involves arranging in a fixed orientation or randomly arranging short fibers or filaments to form a web structure, which is then reinforced by mechanical or thermal bonding or chemical methods. Depending on the production process used, non-woven products can be classified as spunlace non-woven fabric, heat-sealed non-woven fabric, air-laid non-woven fabric, wet non-woven fabric, spunbonded non-woven fabric, melt-blown non-woven fabric, needle-punched woven fabric, stitchbonded nonwoven fabric, etc.

As used herein, the term “prepreg” refers to a fabric impregnated with a thermosetting or thermoplastic resin, which corresponds to an intermediate material commonly used in the preparation of composite materials. For composite materials used in the aerospace industry, high precision requirements exist for the resin content, impregnation uniformity, viscosity and layup of prepregs, which increases the cost of manufacturing such composite materials.

In the context of the present invention, the primary skin layer (a) and the secondary skin layer (g) are not prepregs; that is, they are dry fabrics containing no resin. Since the composite laminate having the honeycomb core described here is prepared by via a liquid molding process, and the method described here has solved the problem of uneven impregnation, the material costs associated with using prepregs as the upper and lower skin layers can be eliminated.

The reinforcing fabrics used as the primary skin layer (a) and secondary skin layer (g) each independently have an areal density ranging from approximately 20 g/m² to approximately 660 g/m², and said reinforcing fabric corresponds to a woven fabric, unidirectional fabric or non-woven fabric.

Barrier Film

As described in the Background Art section, one of the problems to be solved in the manufacture of a composite panel comprising a honeycomb core using a liquid forming process is how to prevent liquid binder from penetrating into the cells of the honeycomb core. In the present invention, this problem is solved by adding a barrier film interspersed between the skin layer and the honeycomb core. A person skilled in the art can select a suitable polymeric material as a separator according to the liquid binder employed.

In the context of the present invention, the primary barrier film (b) and the secondary barrier film (f) each independently comprise ethylene-(meth) acrylate (EA or EMA), anhydride-modified EA or EMA, ethylene-vinyl acetate (EVA), anhydride-modified EVA, ethylene-acid ionomer, polyamide, polyurethane, polyester, polyimide, or a combination thereof.

In some embodiments, the primary barrier film (b) and the secondary barrier film (f) are the same and may include ethylene-(meth) acrylate, anhydride-modified ethylene-(meth) acrylate, ethylene-vinyl acetate, anhydride-modified ethylene vinyl acetate, ethylene acid ionomer, or a combination thereof.

In some other embodiments, the primary barrier film (b) and the secondary barrier film (f) are different and may anhydride-modified ethylene-(meth) acrylate, anhydride-modified ethylene vinyl acetate, ethylene acid ionomer, or a combination thereof.

As used herein, the term “(meth) acrylate” refers to an alkyl acrylate or an alkyl methacrylate.

Said ethylene-(meth) acrylate corresponds to a copolymer comprising polymerized units of ethylene and at least 6 to 40% by weight polymerized units of at least one type of alkyl (meth) acrylate. The alkyl portion of the alkyl (meth) acrylate may contain from 1 to 6 or from 1 to 4 carbon atoms, such as methyl, ethyl, and branched or unbranched propyl, butyl, pentyl and hexyl groups. Preferred alkyl groups include methyl, ethyl and butyl groups, and combinations of two or more of these groups are also preferred. Preferred ethylene-(meth) acrylate copolymers include ethylene-(meth) ethylacrylate and ethylene-(meth) methyl acrylate.

Ethylene-vinyl acetate (EVA) is a copolymer of ethylene and vinyl acetate, wherein the vinyl acetate usually ranges between 5 to 45% by weight, with the balance constituted by ethylene. The properties of EVA are correlated with its vinyl acetate content, molecular weight and melt index. When the melt index is held constant, and vinyl acetate content is increased, the elasticity, flexibility, compatibility, transparency, etc. of the EVA are also improved. When vinyl acetate content is reduced, the performance of the EVA approaches that of polyethylene, rigidity is increased, and wear resistance and electrical insulation are improved. When the content of vinyl acetate is held constant, the molecular weight of EVA increases as the melt index decreases, and impact properties and environmental stress crack resistance correspondingly increase.

As used herein, the term “anhydride-modified polymer” and more specific terms such as “anhydride-modified ethylene-vinyl acetate” and “anhydride-modified ethylene-(meth) acrylate” refer to cases where acid anhydrides of maleic acid (MAH), fumaric acid, etc. are added to a polymer via copolymerization, grafting, or blending. Preferably, the above modified polymers shall bear anhydride functional groups grafted to, or polymerized with, them rather than just blended with them. Usually, the content of the acid anhydride should range from approximately 1 to 20% by weight based on the total amount of the copolymer.

Said anhydride-modified ethylene-(meth) acrylates can be commercially purchased, and include, but are not limited to, DuPont's Bynel® 2100 series; an example of said anhydride-modified ethylene-vinyl acetate is the Dupont Bynel® 3800 series.

As used herein, the term “ionomer” refers to the product of ionic polymerization—i.e., a polymer containing interchain ionic bonds. Said ionomer shall comprise at least one thermoplastic resin selected from a set consisting of metal salts based on olefin/acid copolymers; preferably metal salts based on an ethylene-acid copolymer or an ethylene-(meth) acrylic acid copolymer. As used herein, the term “ionomer” also includes ethylene (meth) acrylic copolymers and ethylene-acid-acrylate terpolymers. Said metal salt corresponds to a neutralizing agent (e.g., an inorganic base) derived from a carboxylic acid group used to at least partially neutralize said copolymer. After neutralization, the ionomer can generally comprise any feasible monovalent or divalent cation, including lithium, sodium, potassium, magnesium, calcium, strontium, copper, zinc and ammonium ions.

Said ethylene-acid ionomer can be commercially purchased, with examples including, but not limited to, DuPont's Surlyn® ionomer series.

See above for information pertaining to aramids; films prepared therefrom demonstrate excellent compaction resistance, thermal stability, and chemical stability. Examples of commercially available aromatic polyamide films include, but are not limited to, Mictron™° produced by Toray, which is a para-aramid film with high rigidity, heat resistance, and barrier properties.

Polyurethane (PU) refers to a polymer containing a characteristic urethane unit in the main chain. Polyurethanes are classified as either one of two types: polyester polyurethanes or polyether polyurethanes. Polyester polyurethanes are prepared using diisocyanate and polyester as raw starting materials. Polyether polyurethanes are polyurethanes prepared from diisocyanates and polyethers. The most commonly used diisocyanates are aromatic diisocyanates, toluene diisocyanate (TDI) and methylene diphenyl diisocyanate (MDI). Commercially available polyurethane films include, but are not limited to, the BASF Elastollan® S85 series, which is a polyether-based polyurethane (polyether polyurethane).

Polyester is a type of thermoplastic polymer containing an ester functional group in its primary chain, which demonstrates various favorable properties such as high dimensional stability, high insulation, chemical resistance, heat resistance, heat aging resistance, abrasion resistance, etc., and its cost of manufacturing is also lower than that of polyamide or polycarbonate. Commercially available polyester films include, but are not limited to, Teijin Teflex™′, which corresponds to a polyethylene terephthalate (PET) film.

Polyimide is a polymer bearing repeating imide units, which offers the advantages of a wide operating temperature range, chemical resistance and high strength. Polyimide is prepared via condensation polymerization of a dianhydride and a diamine in an aprotic polar solvent such as dimethylformamide dimethyl sulfoxide to form a polyamic acid, after which heat curing and dehydration is performed to yield polyimide. Commonly used dianhydrides and diamines include pyromellitic dianhydride (PMDA) and 4,4′-diaminodiphenyl ether. Commercially available polyimide membranes include, but are not limited to, Kapton® manufactured by DuPont.

In the context of the present invention, the primary barrier film (b) and the secondary barrier film (f) each independently have an areal density of approximately 20 g/m² to approximately 100 g/m² and a thickness of approximately 20 μm to approximately 100 μm.

Adhesive Film

In the context of the present invention, the function of the adhesive film is to ensure that the barrier film adheres closely and seals the open pores of the honeycomb core. The adhesive film should preferably take the form of a thin film, which not only has excellent adhesion and durability, but is also easy to work with, with a uniform application volume. Suitable adhesive films include bonding resins with a honeycomb sandwiched structure which are widely used in aerospace, high-speed trains, ships, etc., including epoxy-based films, acrylate-based films and polyurethane-based resin films.

In some embodiments, the primary adhesive film (c) and the secondary adhesive film (e) each independently comprise an epoxy resin, an acrylate resin, or a polyurethane resin.

In other specific embodiments, the primary adhesive film (c) and the secondary adhesive film (e) are the same and are composed of an epoxy resin, an acrylate resin, and a polyurethane resin.

In still other embodiments, the primary adhesive film (c) and the secondary adhesive film (e) are composed of an epoxy resin.

The primary adhesive film (c) and the secondary adhesive film (e) each independently comprise an epoxy resin, an acrylate resin, or a urethane resin; and have a glass transition temperature (T_{g}) of approximately 60° C. to approximately 160° C.

Said primary adhesive film (c) and said secondary adhesive film (e) each independently have a surface density ranging from approximately 100 g/m² to approximately 300 g/m² and a surface density of 100 μm to 300 μm.

Examples of commercially available adhesive films include, but are not limited to, Epoxy Film J69B produced by Heilongjiang Petrochemical Institute with a T_{g} of approximately 100° C.; Acrylate Film MS768 produced by 3M with a T_{g} of approximately 80° C.; and Elastollan® Polyurethane Film S85 produced by BASF with a T_{g} of approximately 80° C.

(d) Honeycomb Core;

In the context of the present invention, said honeycomb core corresponds to a sheet material having a honeycomb structure which is composed of a sheet comprising an aramid, polycarbonate, polypropylene, steel, aluminum, aluminum alloy, or glass fiber. Such sheets having a honeycomb structure are abbreviated herein as “honeycomb panels”, including aramid honeycomb panels, fiberglass honeycomb panels, aluminum honeycomb panels, etc.

The pore walls of the honeycomb panel may be composed of a non-metal foil or a metal foil; wherein said non-metal honeycomb panel is composed of a thin sheet of aramid, polycarbonate, polypropylene, glass fiber, etc. and said metal honeycomb panel is made of metal foil such as steel, aluminum or aluminum alloy. Sheets of non-metallic materials described herein are sometimes referred to as “paper” because of the way in which they are prepared as well as their appearance; they may be prepared using conventional processes and equipment, and include, but are not limited to, meta-aramid paper and para-aramid paper. In addition, the fabrication process used for the honeycomb panels is well known to those skilled in the art.

Said honeycomb core honeycomb panel should preferably be composed of a sheet of meta-aramid paper, para-aramid paper, aluminum foil, aluminum alloy foil and glass fiber; more preferably, the honeycomb panel should be composed of meta-aramid paper and para-aramid paper.

The cross-sectional shape of each pore of the honeycomb panel may be hexagonal, over-expanded hexagonal (or rectangular), circular, or corrugated. The thickness of the honeycomb panel used in the honeycomb core (d) constituting the present invention shall depend on the end use or desired characteristics of the composite laminate. When the density of the honeycomb panel is constant, its weight will increase with thickness. The thickness of the honeycomb panel ranges from approximately 2 mm to approximately 300 mm, pore size ranges from approximately 1.6 mm to approximately 20.0 mm, a pore wall thickness ranges from approximately 0.1 mm to approximately 0.3 mm, and density ranges from approximately 24 kg/m³ to approximately 200 kg/m′.

Examples of commercially available honeycomb panels include, but are not limited to, aramid honeycomb panels such as Hexcel HexWeb® HRH-78 (Nomex® Paper) and HRH-49 (Kevlar® sheets) series honeycomb boards. Commercially available honeycomb panels made from other materials, include, but are not limited to, PC honeycomb panels and polypropylene honeycomb panels (e.g., PP8-80) produced by Qingdao Tubo Sheet Co. Ltd.; Hexcel's aluminum alloy honeycomb panels sold under the trade name Rigicell®, and fiberglass honeycomb panels from the HexWeb® HRP series.

Tubular Rivets

In the context of the present invention, skin layer (a) and skin layer (g) of the composite laminate are composed of a dry fabric rather than a prepreg, and in order to ensure that liquid resin injected from one side can quickly and uniformly infiltrate the skin layer on its opposite side, the present invention provides a solution in which a plurality of tubular rivets are inserted between the two skin layers as a guide duct. In other words, in the composite laminate constituted by the present invention, the layers other than the two skin layers, namely layers (b), (c), (d), (e) and (f), are first stacked in order to form a preform. Thereafter, a plurality of tubular rivets having a suitable hollow tube inner diameter and length are inserted through the preform. The distance by which the tubular rivets are spaced apart can be adjusted according to the viscosity of the liquid adhesive employed and typically ranges between approximately 30 mm and approximately 200 mm, and the tubular rivets should preferably be equidistant from one another. In order to avoid excessively increasing the total weight of the composite laminate, the number of tubular rivets should not be excessive. Additionally, in order not to affect the appearance of the composite laminate, the length of the tubular rivets should be substantially equal to the thickness of the preform. In other words, when the two skin layers are opaque after impregnation, the tubular rivets are hidden as far as the appearance of the composite laminate is concerned, and the appearance will not differ from laminate products which use a prepreg as a skin layer.

As used herein, the term “substantially equal” means the difference between a given value and the reference value shall not exceed 10%, 5%, 3% or 1% of the reference value. For example, when a preform has a thickness of 10 mm, the length of the tubular rivets shall range between 9 mm and 11 mm. Those skilled in the art will understand that as the length of the tubular rivet increases, it becomes less proportional with respect to the thickness of the preform. In general, when the length of the tubular rivet is greater than 20 mm, it should differ from the thickness of the preform by at most 2 mm, and preferably not more than 1 mm, or, more preferably, not more than 0.5 mm

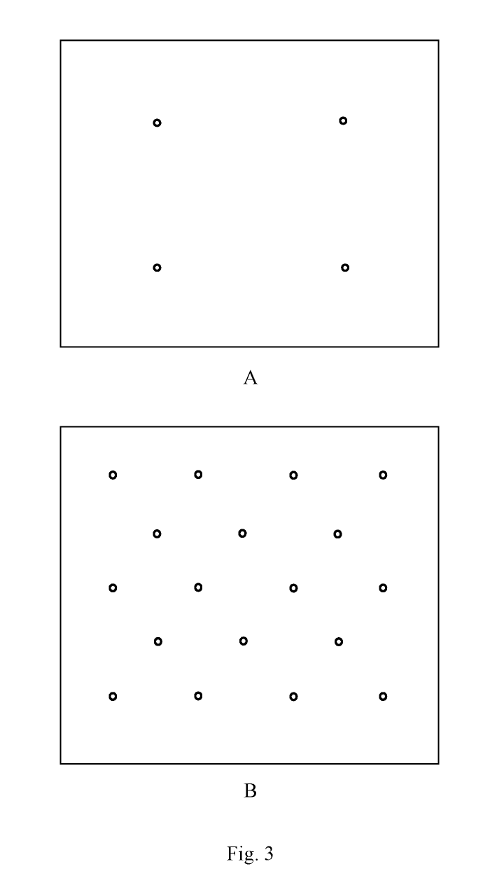

A tubular rivet (see FIG. 2) suitable for use in the present invention shall have a flat nail head of diameter (D1) ranging from approximately 1.6 mm to approximately 20.0 mm, a head thickness (L1) ranging from approximately 0.1 mm to approximately 1.0 mm (L1), a hollow tube of inner diameter (D2) ranging from approximately 1.2 mm to approximately 19.6 mm, a wall thickness (D3) ranging from approximately 0.2 mm to approximately 0.9 mm, and a length substantially equal to the thickness of the preform (L2). The tubular rivet shall be composed of a metallic material and non-metallic material, where said metallic material comprises copper, nickel, aluminum, titanium, an alloy thereof or stainless steel, and said non-metallic material comprises a polyamide or a polyester. A person skilled in the art can select a tubular rivet having a suitable outer diameter depending on the pore size of the honeycomb core material. Commercially available tubular rivets include, but are not limited to, hollow rivets manufactured by Guwanji Hardware Tools Co., Ltd.

Self-Expanding Sealant

In order to fix the tubular rivets in place and fill in the gaps between each rivet and the preform as well as especially the gaps between each rivet and the pores of the honeycomb core, a self-expanding sealant is used for filling and sealing in the present invention. For ease of fabrication, the use of a sealant which provides excellent adhesion, is curable at room temperature, and contains no solvent is preferred. Said self-expanding sealant includes an expandable polystyrene or an expandable polyurethane.

Examples of commercially available products include, but are not limited to, CA-197 polystyrene styrofoam manufactured by the Japanese company Cemedine as well as polyurethane foam produced by the American company SANO.

Liquid Binder Vacuum assisted resin infusion (VARI) is a molding method in which in which bubbles in fabric fibers are removed under a vacuum and liquid binder is injected to penetrate the fiber and fabrics, after which curing is performed. Liquid binders suitable for use in VARI must first have a low viscosity, and preferably the viscosity of the liquid binder at 25° C. should range from 500 cp to 100 cp, and can optionally further include a curing agent. Said liquid binder should have a suitable gelling time, with gelling time at a temperature of 25° C. generally ranging from approximately 5 minutes to approximately 150 minutes. As used herein, the term “gelling time” refers to the time required for the liquid binder to change from a flowable liquid to a solid gel. A person skilled in the art can select a liquid binder having a suitable gel time in accordance with the time required for injection.

In addition, once the liquid binder is cured and it serves as a base matrix within the skin layer, it must demonstrate good heat resistance, flame retardance and chemical resistance, and must also satisfy the mechanical performance requirements of the product according to the specific application.

In the context of the present invention, the liquid binder shall be selected from a set consisting of phenolic resin, epoxy resin, unsaturated polyester resin, vinyl ester resin and combinations thereof.

In some embodiments of the present invention, the liquid binder shall be selected from a set consisting of phenolic resin, epoxy resin, unsaturated polyester resin, vinyl ester resin and combinations thereof.

In some other embodiments of the present invention, the liquid binder shall be selected from a set consisting of phenolic resin, epoxy resin and combinations thereof.

The amount of said liquid binder used shall vary from approximately 40% by weight to approximately 150% by weight or, preferably, approximately 60% by weight to approximately 100% by weight of the total weight of the dry fabric serving as the primary skin layer (a) and the secondary skin layer (g).

Examples of commercially available liquid binders include, but are not limited to, PF7203-1 phenol resin produced by the Jinan Shengquan Group (with viscosity ranging from 150 cp to 250 cp), EPOLAM 2040 epoxy resin produced by the Axson Corporation (viscosity after mixing with hardener: 150 cp to 300 cp), and HS-2102 unsaturated polyester resin (with viscosity ranging from 170 cp to 200 cp) and HS-4430RT epoxy modified vinyl ester resin (with viscosity ranging from 100 cp to 150 cp) produced by Huake Polymers Co., Ltd.

Preparation of the Composite Laminate

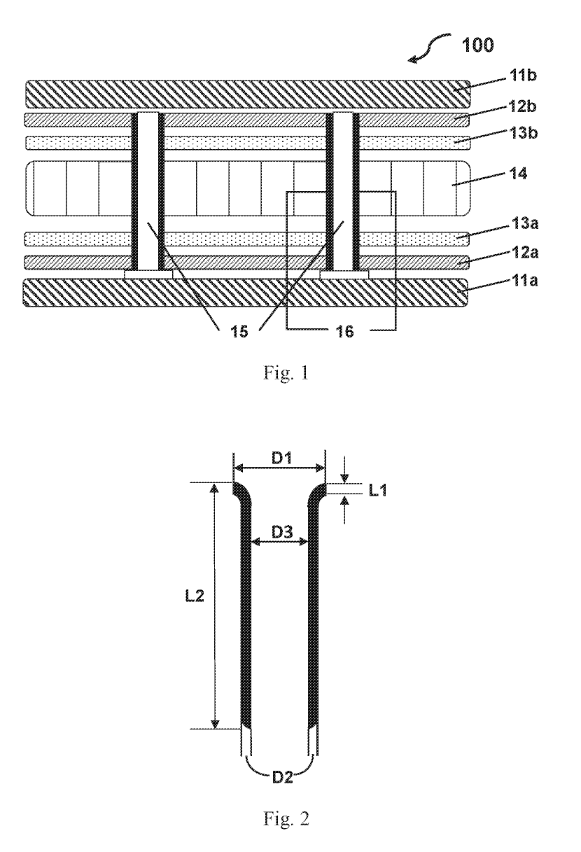

As shown in FIG. 1, the layered structure of the composite laminate 100 constituted by the present invention comprises, in order: (a) a primary skin layer 11a, (b) a primary barrier film 12a, (c) a primary adhesive film 13a, (d) a honeycomb core 14, (e) a secondary adhesive film 13b, (f) a secondary barrier film 12b and (g) a secondary skin layer 11b, (h) a plurality of tubular rivets 15 inserted through the a preform comprising Layer (b) through Layer (f) as well as (i) a self-expanding sealant coving said tubular rivets 16.

In this text, a forward slash (“/”) is used to separate each layer from its adjacent layer to describe the structure of the composite laminate. Therefore, the composite laminate constituted by the present invention can be represented by the notation [(a)/(b)/(c)/(d)/(e)/(f)/(g)]. When the fabric of the primary skin layer (a) is not a single piece of fabric but rather, for example, two pieces of fabric (a1), the corresponding structure can be expressed as [(a1)×2/(b)/(c)/(d)/(e)/(f)/(g)] and when a combination of different fabrics (a1) and (a2) is used for the primary skin layer (a), the corresponding structure can be expressed as [(a1)(a2)/(b)/(c)(d)/(e)/(f)/(g)].

The present invention also provides a method for the manufacture of said composite laminate, wherein:
i) The (b) primary barrier film, (c) primary adhesive film, (d) honeycomb core, (e) secondary adhesive film, and (f) secondary barrier film are stacked sequentially to form a preform;
ii) Multiple tubular rivets are inserted through said preform and set apart from each other in a distance of 30 mm to 200 mm;
iii) The circumference of each tubular rivet is covered with a self-expanding sealant;
iv) The primary skin layer (a) and secondary skin layer (b) are used to cover the outer surface of the preform obtained in Step (iii), respectively;
iv) Vacuum assisted resin infusion (VARI) is used to cure the preform covered with the primary and secondary skin layers obtained in Step (iv).

The procedure used to perform curing using VARI is described in detail below and includes the following steps:
A. Vacuuming: A vacuum (i.e., negative pressure) is applied to a mold containing said [primary skin layer/preform/second skin layer] to remove air contained in the reinforcing fabric serving as the skin layer;
B. Adhesive Infusion: The aforementioned liquid binder is fed in under a vacuum;
C. Curing.

VARI process parameters suitable for use in preparing the composite laminate constituted by the present invention, such as pressure as well as curing temperature and time, generally depend on the liquid binder as well as the materials used for the barrier film, adhesive film, honeycomb core and skin layer. At the same time, the hollow tube inner diameter, number and spacing of the tubular rivets will also affect the length of time over which the adhesive is injected. For example, when the thickness of the preform is held constant, increasing the spacing of tubular rivets of the same size will naturally extend adhesive injection time. Persons skilled in the art can determine appropriate process parameters accordingly.

In the context of the method constituted by the present invention, curing is performed at a pressure of approximately −0.08 MPa to approximately −0.10 MPa and a temperature of approximately 25° C. to approximately 120° C. for a duration of approximately 1 hour to approximately 24 hours; e.g., at 25° C., curing time is typically approximately 24 hours.

In some embodiments, curing is performed with a temperature range of approximately 25° C. to approximately 120° C., approximately 40° C. to approximately 110° C., or approximately 60° C. to approximately 90° C. over a period of approximately 1 hour to approximately 24 hours or approximately 2 hours to approximately 8 hours.

As described in the Background Act section, in the first step of the process of manufacturing a composite laminate comprising a honeycomb core using a liquid forming process, the problem of removing liquid binder from the pores of the honeycomb material must be addressed, and this problem has been solved by employing a barrier film as well as an adhesive film. In addition, there is also a need to solve the problem of ensuring that the two skin layers of the prepreg are uniformly wetted when a resin flow guiding net is not in place and that the manufactured article has at least one surface which is smooth and uniform. The smoothness of said article can be measured using the method given in ASTM D2457. The present invention solves the aforementioned problems by inserting a plurality of tubular rivets to serve as a guide duct and further prevents the liquid binder from penetrating into the porous spaces of the honeycomb core by covering the tubular rivets with a self-expanding sealant. Additionally, since the plurality of inserted tubular rivets are covered by two skin layers, when the primary skin layer and the secondary skin layer constitute an opaque reinforcing fabric following immersion, the composite laminate thus prepared will not be any different in terms of appearance compared to a comparative laminate which uses a prepreg for the skin layers.

Given cost and ease-of-manufacture considerations, in the context of the present invention, the reinforcing fabrics used for said primary skin layer and said secondary skin layer should preferably be the same and the primary barrier film and the secondary barrier film should also be the same, while the primary adhesive film and the secondary adhesive film are also the same.

In a specific embodiment of the present invention, the composite laminate has a laminated structure expressed as [(a)/(b)/(c)/(d)/(c)/(b)/(a)]—i.e., it is constituted by a honeycomb core embedded within a symmetrical sandwiched structure.

In the context of the present invention, composite laminates produced via said method generally have a total thickness ranging from approximately 5 mm to approximately 300 mm and an areal density ranging from 0.35 kg/m² to 20 kg/m². The total thickness and areal density of the composite laminate constituted by the present invention can be easily adjusted by using honeycomb cores of different thicknesses and densities as well as reinforcing fabrics for the primary and secondary skin layers.

Because liquid forming is employed in the fabrication process, tubular rivets are used as guide ducts and non-prepreg skin layers are used, articles or components including the composite laminate constituted by the present invention, article or components consisting essentially of a composite laminate constituted by the present invention, articles or component consisting of a composite laminate constituted by the present invention or articles or components produced via the composite laminate manufacturing method constituted by the present invention, not only are material, equipment and production costs greatly decreased, the integrity of the structure and appearance of said articles are maintained and they have at least one surface that is smooth and uniform, provided that one side of the mold used in the preparation process is smooth.

The composite laminate constituted by the present invention can be used to prepare articles or components used in vehicles or mobile temporary dwellings, with examples including, but not limited to: use in the manufacture of articles and components used in transportation vehicles including automobiles, ships, trains, maglev trains, drones and airplanes; as well as movable temporary dwellings, including parts used in shelters and mobile homes. Said articles or component include, but are not limited to, floor panels, skirtboards, roof panels, a wall panels, luggage racks, shelter panels, partitions, as well as other secondary structural members.

### Embodiment Examples

The abbreviation “E” is used to mean “Embodiment Example” while the abbreviation “CE” is used to mean “Comparative Example” and trailing numbers indicate in which Embodiment Example a given composite sheet sample was prepared. Both the Embodiment Examples and Comparative Examples were prepared and tested in a similar manner. Percentages are given by weight unless otherwise indicated.

Materials
Dry Fabric (a1): Fiberglass fabric produced by Changzhou Huali Kexin Material Co., Ltd., constituting a 0° and 90° biaxial woven fabric and stitch-punched unidirectional fabric with an areal density of 658 g/m², water content of <0.2% and a silane surface treatment.
Dry Fabric (a2): Para-aramid fabric produced by Jiangsu Tianniao Gaoxin Tech Co., Ltd., constituting a plain weave fabric having an areal density of 220 g/m², a water content of <3.5%, and a silane surface treatment.
Prepreg (a′): Purchased from Gurit; a glass fiber fabric prepreg having an areal density of 520 g/m² and containing 42% phenolic resin, computed based on the total weight of the prepreg.
Prepreg (a″): Purchased from Yixing Huaheng High Performance Fibre Weaving Co., Ltd.; a para-aramid fabric prepreg with an areal density of 523 g/m² and 42% epoxy resin, computed based on the total weight of the prepreg.
Barrier Film (b1): Bynel® 3861 film supplied by DuPont, constituting an anhydride-modified EVA film with a thickness of 50 μm, an areal density of 49 g/m², a melting point of 80° C. and a Vicat softening point of 56° C.
Adhesive Film (c1): J69B bisphenol A epoxy film purchased from Heilongjiang Petrochemical Institute, having a thickness of 250 μm, an areal density of 292 g/m² and a T_{g} of 100° C.
Honeycomb Panel (d1): JY1-4.8 purchased from Jiangsu Junyuan, is a meta-aramid honeycomb panel made of Nomex® T722 paper with hexagonal pores and a pore size of 4.8 mm, honeycomb density of 48 kg/m³ and a thickness of 10 mm.
Tubular Rivets: Hollow copper rivets manufactured by Guwanji Manufacturing, with a flat head diameter of 5.9 mm and thickness of 0.5 mm; hollow tube inner diameter of 3.2 mm, outer diameter of 3.9 mm, and wall thickness of 0.35 mm; as well as a rivet length of 10 mm
Self-Expanding Sealant: Swellable polyurethane adhesive manufactured by SANO, with a foaming temperature ranging from 5° C. to 35° C. and a foaming multiple of 80.
Liquid Binder 1: Phenolic Resin No. PF7203-1 produced by Jinan Shengquan Group which includes a curing agent (PF7203-1A) and has a mixing ratio of 100:7 (by weight) and viscosity at 25° C. of 150 cp to 250 cp.
Liquid Binder 2: Epoxy resin produced by Axson under the resin model number EPOLAM 2040, which includes a curing agent (EPOLAM 2047) and has a mixing ratio of 100:32 (by weight) and viscosity at 25° C. of approximately 290 cp.

### Methods Used to Prepare Composite Laminates in Embodiment Examples 1-2 and Comparative Examples 1-2

### Embodiment Example 1

Two sheets of barrier film (b1) cut into squares having a side length of 40 cm, two sheets of adhesive film (c1), and one honeycomb panel (d1) were sequentially stacked to prepare a preform having the structure [(b1)/(c1)/(d1)/(c1)/(b1)]. Four hollow copper rivets (4 mm inner diameter, 10 mm in length) were inserted through the preform; the positions of the individual rivets were 100 mm from the edges of the preform and they were separated 200 mm from each other (see FIG. 3A); expandable polyurethane adhesive was then used to seal the peripheral gaps around each rivet. A stripping agent was applied to a clean flat glass mold (square-shaped with a side length of 60 cm and a thickness of 5 mm), and a primary dry glass fabric (a1) serving as the primary skin layer (40 cm×40 cm), a preform with a tubular rivet inserted, and a secondary dry fiberglass fabric (a1) serving as a secondary skin layer were thereafter placed on the mold in sequence. A Nylon 6 release cloth (square shaped with a side length of 50 cm and a thickness of 0.1 mm) serving as a consumable layer was then placed on top of the secondary skin layer, followed by, in sequence, a polypropylene release film (square shaped with a side length of 50 cm and a thickness of 0.1 mm) and a polyester flow net (square shaped with a side length of 50 cm and a thickness of 2.5 mm) Finally, the positions of the vacuum tube, the inlet tube and the overflow tube as well as a vacuum bag (squares shaped with a side length of 70 cm and a thickness of 0.05 mm) covered with two layers of Nylon 6 were fixed in place and the layers were sealed with tape.

A vacuum was then applied to the mold containing the preform to remove air from the areas between the dry fabric fibers at a vacuum pressure ranging from −0.08 MPa to −0.1 MPa. Approximately 300 g of Liquid Binder 1 (a phenolic resin binder) was infused from the inlet tube and the degree of infiltration of the skin layers on both sides was observed until excess liquid binder was discharged from the overflow tube after approximately 30 minutes. Once adhesive infusion was complete, the mold was placed in an oven and vacuum pressure was maintained at −0.08 MPa to −0.10 MPa, and the temperature was maintained at 70° C. as curing was performed for 5 hours. Thereafter, heating was stopped, the vacuum was turned off and once the sample cooled down to room temperature, it was taken out of the oven; the vacuum bag and the consumable layer were then removed to obtain a laminate corresponding to a specific embodiment of the composite laminate constituted by the present invention and the surface on the side which was attached to the flat glass mold was smooth, with laminated structure [(a1)/(b1)/(c1)/(d1)/(c1)/(b1)/(a1)]. Based on an estimate performed by subtracting the weights of the raw materials used in each layer from the weight of the laminate the amount of matrix derived from Liquid Binder 1 was 67% of the total weight of the primary skin layer and secondary skin layer (i.e., total dry fabric), equivalent to approximately 40% matrix content within the skin layer following curing.

### Embodiment Example 2

The materials and methods used for production were the same as those used in Example 1, with the exception that the dry fabric used for the upper and lower skin layers was constituted by three para-aramid fabric sheets (a2) for each layer and Liquid Binder 2 (an epoxy resin adhesive) was used during adhesive injection. The laminated structure of laminate thus obtained was [(a2)×3/(b1)/(c1)/(d1)/(c1)/(b1)/(a2)×3], and the surface on one side was smooth. The amount of matrix derived from Liquid Binder 2 was 67% of the total weight of the primary skin layer and secondary skin layer, equivalent to approximately 40% matrix content within the skin layer following curing.

### Comparative Example 1

Six prepreg sheets (a′) cut into squares having a side length of 40 cm, two sheets of adhesive film (c1), and one honeycomb panel (d1) of the same dimensions were sequentially stacked to prepare a preform having the structure [(a′)×3/(c1)/(d1)/(c1)/(a′)×3].

A sheet of primary release paper was placed on a flat stainless steel mold (consisting of two 60 cm×60 cm×3 cm stainless steel plates) and said preform was placed in the center of the mold thereupon, after which a sheet of secondary release paper (50 cm×50 cm) was placed on the preform and the mold was closed. Next the mold was placed inside a hot press (manufactured by Shanghai Yeshuai Co.) which was preheated to 120° C. and the press was closed to perform hot pressing at a pressure of 0.2 MPa for 60 minutes at 120° C. Once hot pressing was complete, the mold was removed from the hot press and the sample was cooled to room temperature to obtain Comparative Example 1 Laminate having the structure [(a′)×3/(c1)/(d1)/(c1)/(a′)×3].

### Comparative Example 2

With the exception that the prepregs used as the upper and lower skin layers were constituted by three prepreg sheets (a″) containing 42% epoxy resin, the material used for the honeycomb core and the production process were the same as Comparative Example 1, and the obtained laminate had the structure [(a″)×3/(c1)/(d1)/(c1)/(a″)×3].

Test Methods

Tensile Strength: Laminate sheets (40 cm×40 cm) prepared in Embodiment Examples 1-2 and Comparative Examples 1-2 were cut into multiple test specimens (5 cm×5 cm) and tensile strength in the thickness direction was tested according to the method described in the ASTM C297 standard; the results are shown in Table 1. We observed that the failure forms of all test samples corresponded to the honeycomb core, thereby confirming that adhesion between the layers of the laminates obtained for said Embodiment Examples was good, with no delamination issues noted.

Thickness: The thickness of each laminate sample was measured using micrometer callipers. Each sample was measured 3 to 5 times at different points, and the results were averaged and reported in Table 1.

Area Density: The length and width of the laminate sample were measured with a ruler, weight was measured using a balance and weight per unit area was calculated, with the averaged results shown in Table 1.

Glossiness: In accordance with the method specified in ASTM D2457, surface glossiness was measured for each laminate sheet sample unit at an angle of incidence of 60 deg., with the results specified in GU (gloss units); the higher the value, the smoother the tested surface.

TABLE 1

| | | | | Tensile |
|---|---|---|---|---|
| | Glossiness | Areal Density | Thickness | Strength |
| Sample | (GU) | (kg/m²) | (mm) | (MPa) |
| E1 | Smooth Surface: 63.1 | 4.632 | 11.32 | 2.12 |
| | Rough Surface: 5.6 | | | |
| CE1 | 34.0 | 4.256 | 12.30 | 1.90 |
| E2 | Smooth Surface: 86.4 | 3.468 | 11.95 | 2.94 |
| | Rough Surface: 1.5 | | | |
| CE2 | 29.6 | 3.227 | 11.85 | 2.40 |

The following are apparent from the results given in Table 1.

The surface density and thickness of Laminated Board E1 obtained via the method for producing a composite laminate constituted by the present invention show numerical values comparable to CE1, and the value of the tensile strength of E1 is also slightly higher than the corresponding value for CE1. Because the surface glossiness of the composite panel depends primarily on the mold used and the flatness of the fabric used for the skin layer, comparing the glossiness of the smooth surface of E1 with that of the surface of CE1, it can be inferred that the surface of the flat glass mold used for the preparation of E1 was somewhat smoother than the surface of the stainless steel mold used to prepare CE1. Similarly, the same inference can be obtained by comparing the glossiness data obtained for the smooth surface of E2 with that of the CE2 surface.

In a typical vacuum-based process, in order to obtain a composite board fully impregnated with adhesive, it is necessary to use an auxiliary flow guiding material, similar to the consumable layer placed on the secondary skin layer in Embodiment Example 1, so that the glossiness of the surface of the corresponding article is expected to be similar to the glossiness values of the rough faces obtained in Embodiment Examples 1 and 2. In contrast, for a composite laminate constituted by the present invention, the fabric of the skin layer can be directly attached to the surface of the mold via the method provided by the present invention, making it possible to obtain a composite sheet having at least one smooth surface. Comparing the glossiness values of the smooth and rough faces of E1, it can be confirmed that the method provided by the present invention has an advantage over the typical vacuum-based process in that the composite laminate constituted by the present invention which is obtained has at least one surface which is smooth and uniform.

In some embodiments of the present invention, the smooth surface of the composite laminate constituted by the present invention shows a glossiness of at least greater than 10, greater than 25, or greater than 50, wherein said glossiness is measured in accordance with the method described in ASTM D2457, at an angle of incidence of 60 degrees.

While the present invention has been described and illustrated in the above exemplary embodiments, the above descriptions are not intended to limit the scope of the invention to the details given therein as various types of modifications and substitutions can be performed without departing from the spirit of the present invention. Accordingly, variations and equivalents of the invention disclosed herein will be apparent to persons skilled in the art, and all such variations and equivalents shall be considered to fall within the spirit and scope of the invention as defined by the following claims.

1. A composite laminate having a honeycomb core, comprising in sequence:
(a) a first skin layer,
(b) a first barrier film,
(c) a first adhesive film,
(d) a honeycomb core,
(e) a second adhesive film,
(f) a second barrier film,
(g) a second skin layer,
(h) a plurality of tubular rivets,
(i) a self-expanding sealant sealed around the tubular rivets, and
(j) a matrix derived from a liquid binder,
wherein
the liquid binder is selected from the group consisting of phenolic resin, epoxy resin, unsaturated polyester resin, vinyl ester resin and combinations thereof; and has a viscosity of 100 cp to 500 cp at 25° C.;
the layers (b), (c), (d), (e) and (f) are stacked in sequence to form a preform; and
the tubular rivets are inserted through the preform and set apart from each other by a distance of 30 mm to 200 mm.

2. The composite laminate as claimed in claim 1, wherein
the first skin layer (a) and the second skin layer (g) are not prepregs; and each independently comprises at least one reinforcing fabric comprising glass fibers, carbon fibers, aramid fibers or combinations thereof;
each of the first barrier film (b) and the second barrier film (f) independently comprises ethylene (meth)acrylate, anhydride-modified ethylene (meth)acrylate, ethylene vinyl acetate, anhydride-modified ethylene vinyl acetate, ethylene-acid ionomer, polyamide, polyurethane, polyester, polyimide or combinations thereof;
each of the first adhesive film (c) and the second adhesive film (e) independently comprises epoxy resin, acrylate resin or polyurethane resin; and has a glass transition temperature of 60° C. to 160° C.;
the honeycomb core (d) is a board having a honeycomb structure made of thin sheets composed of aramid, polycarbonate, polypropylene, steel, aluminum, aluminum alloy or glass fiber; and the cross-sectional shape of each cell of the honeycomb board is hexagonal, overexpanded hexagonal, circular or corrugate; and
the self-expanding sealant is composed of expandable polystyrene or expandable polyurethane.

3. The composite laminate as claimed in claim 1, which has a total thickness of 5 mm to 300 mm, and an areal density of 0.35 Kg/m² to 20 Kg/m².

4. The composite laminate as claimed in claim 1, wherein the reinforcing fabric for use as the first skin layer (a) and the second skin layer (g) each independently has an areal density of 20 g/m² to 660 g/m² and the reinforcing fabric is a woven fabric or a non-woven fabric.

5. The composite laminate as claimed in claim 1, wherein each of the first barrier film (b) and the second barrier film (f) independently has an areal density of 20 g/m² to 100 g/m² and a thickness of 20 mm to 100 mm.

6. The composite laminate as claimed in claim 1, wherein each of the first adhesive film (c) and the second adhesive film (e) independently has an areal density of 100 g/m² to 300 g/m² and a thickness of 100 mm to 300 mm.

7. The composite laminate as claimed in claim 1, wherein the honeycomb core (d) is a honeycomb board composed of m-aramid paper or p-aramid paper, has a thickness of 2 mm to 300 mm, a cell size of 1.6 mm to 20.0 mm, a cell wall thickness of 0.1 mm to 0.3 mm, and a density of 24 Kg/m³ to 200 Kg/m³.

8. The composite laminate as claimed in claim 1, wherein each tubular rivet has a flat head of 1.6 mm to 20.0 mm in diameter, a nail head thickness of 0.1 mm to 1.0 mm, a hollow tubular portion with an inner diameter of 1.2 mm to 19.6 mm, and a wall thickness of 0.2 mm to 0.9 mm, and the length substantially equals the thickness of the preform; and the tubular rivet is composed of metallic and non-metal materials, the metallic materials comprise copper, nickel, aluminum, titanium, an alloy thereof or stainless steel; and the non-metal materials comprise polyamide or polyester.

9. The composite laminate as claimed in claim 1, wherein the amount of the matrix derived from a liquid binder resin is 40 weight % to 150 weight % of the combined weight of the first skin layer (a) and the second skin layer (g).

10. A method for manufacturing the composite laminate as claimed in claim 1, comprising:
i) Sequentially stacking the layers: (b) a first barrier film, (c) a first adhesive film, (d) a honeycomb core, (e) a second adhesive film and (f) a second barrier film to form a preform;
ii) inserting a plurality of tubular rivets through the preform, set apart from each other by a distance of 30 mm to 200 mm;
iii) sealing around each tubular rivet with a self-expanding sealant;
iv) laying a first skin layer and a second skin layer over the outer surfaces of the preform obtained in step (iii) respectively; and
v) curing the preform, covered with the first and second skin lays, obtained in step (iv) by a vacuum-assisted resin infusion (VARI) method.

11. The method as claimed in claim 10, wherein the curing step is performed at 25° C. to 120° C. under a pressure of −0.08 MPa to −0.10 MPa for 1 hour to 24 hours.

12. Articles or parts for transportation vehicles or movable homes, the articles or parts comprising the composite laminate as claimed in claim 1, wherein the transportation vehicles include automobiles, ships, trains, magnetically levitated trains, unmanned aerial vehicles and aircrafts, and the movable homes include cabins and mobile homes.

13. The use of the composite laminate as claimed in claim 1 for articles or parts for transportation vehicles or movable homes, wherein the transportation vehicles include automobiles, ships, trains, magnetically levitated trains, unmanned aerial vehicles and aircrafts, and the movable homes include cabins and mobile homes.

14. A composite laminate comprising:
a preform sandwiched between a first fibrous skin layer and a second fibrous skin layer, wherein the preform comprises in order:
a first barrier film,
a first adhesive film,
a honeycomb core,
a second adhesive film,
a second barrier film;
wherein the preform further comprises a plurality of tubular rivets inserted through the thickness of the preform and having a length substantially equal to the thickness of the preform, the rivets being set apart from each other at a distance of 30 mm to 200 mm;
wherein a self-expanding sealant is sealed around the tubular rivets within the cells of the honeycomb core; and
wherein a matrix derived from a liquid resin comprising phenolic resin, epoxy resin, unsaturated polyester resin, vinyl ester resin, or combinations thereof is infused into the first fibrous skin layer and the second fibrous skin layer.

15. The composite laminate of claim 14, wherein
each of the first fibrous skin layer and the second fibrous skin layer independently comprises at least one reinforcing fabric, the fabric comprising glass fibers, carbon fibers, aramid fibers, or combinations thereof;
each of the first barrier film and the second barrier film independently comprises ethylene (meth)acrylate, anhydride-modified ethylene (meth)acrylate, ethylene vinyl acetate, anhydride-modified ethylene vinyl acetate, ethylene-acid ionomer, polyamide, polyurethane, polyester, polyimide, or combinations thereof;
each of the first adhesive film and the second adhesive film independently comprises epoxy resin, acrylate resin, or polyurethane resin, the resin having a glass transition temperature of 60° C. to 160° C.;
the honeycomb core comprises aramid, polycarbonate, polypropylene, steel, aluminum, aluminum alloy, or glass fiber; and
the self-expanding sealant is of expandable polystyrene or expandable polyurethane.

16. The composite laminate of claim 14, having a total thickness of 5 mm to 300 mm, and an areal density of from 0.35 Kg/m² to 20 Kg/m².

17. The composite laminate of claim 15, wherein each reinforcing fabric has an areal density of 20 g/m² to 660 g/m² and is a woven fabric or a unidirectional fabric or a non-woven fabric.

18. The composite laminate of claim 14, wherein each of the first barrier film and the second barrier film independently has an areal density of 20 g/m² to 100 g/m² and a thickness of 20 μm to 100 μm.

19. The composite laminate of claim 15, wherein the honeycomb core comprises m-aramid paper or p-aramid paper and has a thickness of 2 mm to 300 mm, a cell size of 3.2 mm to 9.6 mm, a cell wall thickness of 0.1 mm to 0.3 mm, and a density of 24 Kg/m³ to 200 Kg/m³.

20. The composite laminate of claim 14, wherein the amount of infused liquid resin is from 40 weight % to 150 weight % of the weight of dry fabric of the first skin layer and the second skin layer.
